(19) United States
(12) Patent Application Publication
(10) Pub. No.: US 2026/0275959 A1
(43) Pub. Date: Sep. 17, 2026

(54) TURBINE BLADE

(71) Applicant: THE UNIVERSITY COURT OF THE UNIVERSITY OF EDINBURGH, Edinburgh (GB)

(72) Inventors: Ignazio Maria VIOLA, Edinburgh (GB); Stefano GAMBUZZA, Edinburgh (GB); Edward MCCARTHY, Edinburgh (GB)

(73) Assignee: THE UNIVERSITY COURT OF THE UNIVERSITY OF EDINBURGH, Edinburgh (GB)

(21) Appl. No.: 19/472,202

(22) PCT Filed: Apr. 2, 2024
(86) PCT No.: PCT/GB2024/050899

§ 371 Date: Oct. 3, 2025

(30) Foreign Application Priority Data
Apr. 4, 2023 (GB) 2305007.3

(51) Int. Cl. F03D 1/06; F03B 3/12; F03B 13/26

(52) U.S. Cl. CPC F03D 1/0675; F03B 3/121; F03B 13/26; F05B 2240/301; F05B 2240/304; F05B 2240/31; F05B 2270/1095

(57) ABSTRACT

A turbine blade (10), a turbine (1) comprising said turbine blade (10), a trailing edge assembly (11′, 11″, 111′) for a turbine blade (10′, 10″, 110′) and a kit of parts for a turbine blade (10′, 10″, 110′). The turbine blade (10) comprising a leading edge (12), a trailing edge (14), a pressure side (16), and a suction side (18); wherein each of the pressure side (16) and the suction side (18) extend between the leading edge (12) and the trailing edge (14); wherein the pressure side (16) is formed of a first wall (20); wherein the suction side (18) is formed of a second wall (22); and wherein the first wall (20) and the second wall (22) are configured to be independently deformable and move relative to each other proximal the trailing edge (14) in response to loading on the turbine blade (10).

### FIELD

This relates to a turbine blade, e.g. a turbine blade for use with a tidal turbine or a wind turbine, to a turbine comprising one or more of the turbine blades, to a trailing edge assembly for a turbine blade, and a kit of parts for a turbine blade. In particular, this relates to an adaptable camber turbine blade.

### BACKGROUND

Tidal energy offers an attractive source of renewable energy, due to the reliability of the tidal energy source. At present, the levelised cost of energy (LCOE) for energy generated by tidal turbines is higher than energy generated by offshore wind turbines. LCOE is the minimum constant price at which electricity has to be sold in order to break-even over the lifetime of the project. A key driver for LCOE is the cost of blade failure and inefficient power generation. These factors particularly impact the LCOE for tidal turbines because they experience constantly varying load due to the turbulent and sheared inflow in which they operate. The impacts of these flow conditions can include strain on blades and turbine systems leading to increased failure, uneven power generation leading to lower efficiency, inefficient power take-off and/or generator deployment.

Unsteady load mitigation technology can increase reliability and reduce costs and is critical to reduce the LCOE and provide more competitive renewable energy. One emerging approach to achieve this is a blade which changes geometry in response to conditions (morphing blades). Known morphing blades rely on active morphing systems comprising sensors and actuators.

A typical parameter to define turbine blade geometry is the camber of the turbine blade which is the asymmetry between the pressure surface and suction surface of the turbine blade. The lift coefficient of the turbine blade may depend on the camber of the blade.

### SUMMARY

Aspects of the present disclosure relate to a turbine blade, e.g. a turbine blade for use with a tidal turbine or a wind turbine, and to a turbine comprising one or more of the turbine blades.

In a first aspect there is provided a turbine blade comprising:
a leading edge;
a trailing edge;
a pressure side; and
a suction side,
wherein each of the pressure side and the suction side extend between the leading edge and the trailing edge,
wherein the pressure side is formed of a first wall,
wherein the suction side is formed of a second wall, and
wherein the first wall and the second wall are configured to be independently deformable so as to move relative to each other proximal the trailing edge in response to loading on the turbine blade.

In use, varying loads acting on the turbine blade may cause the first and/or second walls to deform and move relative to each other proximal the trailing edge of the turbine blade. The varying loads may occur as a result of different fluid flow fields around the turbine blade and thus fluid dynamic pressure and shear acting on the turbine blade. The fluid may be water or air. The deformation of the first and/or second walls may cause a change in camber of the turbine blade. The turbine blade may thus comprise or take the form of an adaptable camber turbine blade, in particular a passively adaptive camber turbine blade. The camber may change according to the loading on the turbine blade to mitigate unsteady loads.

Beneficially, the deformation of the walls may mitigate or limit load fluctuations on the turbine blade. In particular, the turbine blade may provide both a means to control thrust and torque in the presence of slow velocity changes (such as, for instance, changes in the free-current speed) and in the presence of rapid transients such as those caused by freestream turbulence. Further, the walls may allow these advantages to be obtained via a passive system that does not require sensing and actuating mechanisms. The turbine blade may mitigate loads, for example, up to 20% higher than a standard operating load.

The first and second walls may deform instantaneously or near instantaneously in response to loading on the turbine blade. Beneficially, this provides highly responsive load mitigation.

The turbine blade may be suitable for use in a tidal turbine. The turbine blade may be suitable for use in a wind turbine.

The turbine blade may be configured for retro-fit to an existing turbine.

The turbine blade may be substantially hollow. In particular, the turbine blade may be hollow at least in the region of the trailing edge.

The turbine blade may comprise a root. In use in a turbine, the root may be proximal a hub of the turbine.

The turbine blade may comprise a tip. In use in a turbine, the tip may be distal a hub of the turbine.

The turbine blade may define a longitudinal axis extending between the root and the tip. The length along the longitudinal axis between the root and the tip may be referred to as the blade span.

Each wall may be a sheet of material, e.g. a thin sheet of material. Each wall may extend between the root and the tip of the turbine blade. Each wall may extend between the leading edge and the trailing edge.

In response to loading on the turbine blade:
(i) the first wall may move relative to the second wall;
(ii) the second wall may move relative to the first wall; and/or
(iii) the first wall and the second wall may both move, e.g. move simultaneously, relative to each other.

The first wall may define the pressure side of the turbine blade. The first wall may have an S shaped form, e.g. an open or loose S shaped form, or an arc shaped form, between the leading edge and the trailing edge. The first wall may maintain the same shape form, but straighten or bend under varying load. Alternatively, the first wall may straighten or bend between S and arc shape form under varying load.

The second wall may define the suction side of the turbine blade. The second wall may have an S shaped form, e.g. an open or loose S shaped form, or an arc shaped form, between the leading edge and the trailing edge. The second wall may maintain the same shape form, but straighten or bend under varying load. Alternatively, the second wall may straighten or bend between S and arc shape form under varying load. The first and second walls may be connected at the leading edge. The first and second walls may be contiguous. The first and second walls may be integrally formed. Alternatively, the first and second walls may be coupled, directly or indirectly, at or proximal the leading edge.

The first wall may comprise or be formed of a first material. The second wall may comprise or be formed of a second material. The first and second materials may be the same material or different materials.

Each wall may have a single ply thickness. Alternatively, each wall may be formed as a multi-ply laminate.

The first and/or second material may comprise or be formed of a composite material. The composite material may feature woven or braided fibre material. The composite material may be Glass-Fibre Reinforced Polymer (GFRP). Beneficially, the composite material may provide the walls with fatigue resilience.

Fibres of the composite material may be unidirectional. Fibres of the composite material may be directed longitudinally from the root to the tip of the blade. Beneficially this may provide a resistance to bending of the turbine blade along the longitudinal axis, while allowing the deformation of the walls on a plane perpendicular to the longitudinal axis.

Alternatively, the fibres may be arranged at an angle relative to the longitudinal direction. The fibres may be laid in a +45° orientation.

Alternatively, the first and/or second material may be an isotropic material.

The first and/or second material may comprise or be formed of elastomer. The first and/or second material may be a composite material comprising elastomer. The first and/or second material may be an isotropic material formed of elastomer.

Each wall may be flexible at least proximal the trailing edge.

The stiffness of the walls may be selected so that a camber of the turbine blade may reduce under high load, e.g. higher-than-design load. The first and second walls may straighten under high load. The first and second walls may straighten at least proximal the trailing edge under high load. In use, this may limit the maximum loads generated by the turbine to provide a limit to the maximum torque (and thus, power) transferred to a turbine generator, and to the thrust and other moments transferred to the structure of the turbine blade and turbine. In this manner, the turbine may be protected from transient surges in torque and thrust that may damage the turbine.

Vice-versa, under low load, e.g. lower-than-design load, the camber of the turbine blade may increase. The first and second walls may bend under low load. The first and second walls may bend at least proximal the trailing edge under low load. In use, the deformation of the first and second walls under low load may increase the power generated by the turbine.

The first and second walls may have the same thickness or different thicknesses. The thickness of the first and second walls and/or relative thicknesses of the first and second walls, may determine the deflection of the first and second walls and/or separation between the first and second walls at the trailing edge. The first wall may have a uniform thickness. The second wall may have a uniform thickness.

The turbine blade may be flexible proximal the trailing edge. The turbine blade may be rigid proximal the leading edge. The leading edge may be more rigid/less flexible than the trailing edge.

One or both of the first and second walls may comprise a flexible portion and a rigid portion, e.g. the rigid portion may be more rigid/less flexible than the flexible portion. The flexible portion may be longer than the rigid portion. The flexible portion may comprise the trailing edge. The rigid portion may comprise the leading edge. The turbine blade may define a quarter-chord. The rigid portion may extend, for example, between the leading edge and the quarter-chord.

The first and/or second walls may have uniform thickness. Alternatively, the thickness of the first and/or second walls may be variable across said walls. The flexible portion may have a uniform thickness. The rigid portion may have a larger thickness than the flexible portion.

The rigid and flexible portions may be formed using a ‘ply-drop’ technique.

The turbine blade may comprise a rigid element. The rigid element may be positioned closer to the leading edge than to the trailing edge. The rigid element may be proximal the leading edge. The rigid element may be proximal the quarter-chord position. The rigid element may, for example, extend between the leading edge and the quarter-chord position. Beneficially, this may allow the trailing edge of the turbine blade to be flexible (e.g. elastically deformable) while the leading edge is rigid, e.g. leading edge is substantially less flexible than the trailing edge. The walls may be flexible between the quarter-chord position and the trailing edge. The rigid element may retain the shape of the leading edge.

The first and second walls may be coupled to the rigid element.

The rigid element may be in the form of a rigid bar. The rigid bar may extend between the first wall and the second wall. The rigid bar may be positioned closer to the leading edge than to the trailing edge. The rigid bar may be positioned at the quarter-chord position. The thicker portion of the first and/or second wall may be a portion of the wall between the leading edge and the rigid bar.

The rigid element may be in the form of a rigid block. The rigid block may fill a volume of the turbine blade at the leading edge and between the first and second walls. The rigid block may fill the turbine blade between the leading edge and the quarter-chord position. The remaining volume of the turbine blade may be substantially hollow.

The first and second walls may be configured to move independently of each other. The first and second walls may be configured to rotate, e.g. bend, curl or straighten, independently of each other. The first and second walls may be configured to translate independently of each other at the trailing edge. The first and second walls may translate in a direction perpendicular to a plane defined by a chord of the turbine blade and the longitudinal axis of the turbine blade. The first and second walls may translate in a direction along a chord of the turbine blade, e.g. in a chord-wise direction. The first and second walls may rotate around the quarter-chord position.

The first and second walls may contact each other at the trailing edge under design load conditions. The first and second walls may be configured to move in and out of contact at the trailing edge under varying load. The first and second walls may be separated at the trailing edge. In particular, the first and second walls may be separated at the trailing edge when under no load, e.g. in a neutral position.

The turbine blade may have an open geometry. The first and second walls may not be connected, e.g. directly and/or rigidly connected, at the trailing edge. This may maximise the relative deformation that is available between the first and second walls at the trailing edge. The open geometry may also mitigate buckling of the first and second walls to prevent interruptions to hydrodynamic flow over the turbine blade.

At the trailing edge there may be a gap between the first and second walls..

The turbine blade may comprise a joining member.

The joining member may connect, e.g. indirectly connect, the first and second walls at the trailing edge.

The joining member may be configured to permit the independent deformation and relative movement of the first and second walls proximal the trailing edge. The joining member may limit the extent of relative movement available between the first and second walls proximal the trailing edge.

The joining member may be in the form of a ribbon, a cap, a skin or the like.

The joining member may comprise or be formed of elastomer.

In a second aspect there is provided a turbine comprising one or more turbine blades according to the first aspect.

Beneficially, the deformation of the walls of the turbine blades may mitigate or limit load fluctuations on the turbine. The deforming turbine blade may provide a means to control the load on the turbine in the presence of slow variations of the mean flow speed (e.g. changes over a period of minutes) and in the presence of rapid velocity changes (e.g. changes over a period of seconds such as due to freestream turbulence and/or shear flow). The turbine blade may mitigate loads, for example, up to 20% higher than a standard operating load.

The turbine may comprise a hub.

The one or more turbine blades may be attached to the hub. The hub may define an axis. The axis may extend through the hub, e.g. through the centre of the hub. The one or more turbine blades may extend radially from the hub. The turbine blades may be rotatable around the axis in response to loading on the one or more turbine blades. The turbine may comprise a plurality of turbine blades according to the first aspect.

The turbine blades may be equally spaced circumferentially around the axis.

The turbine may be a tidal turbine or a wind turbine. The tidal turbine may be a kW or MW scale tidal turbine. The wind turbine may be a kW or MW scale wind turbine.

In a third aspect there is provided a trailing edge arrangement for a turbine blade, the trailing edge arrangement comprising:
a first wall portion configured to form at least a portion of a pressure side of the turbine blade, and
a second wall portion configured to form at least a portion of a suction side of the turbine blade,
wherein the first wall portion and the second wall portion are configured to be independently deformable so as to move relative to each other proximal the trailing edge of the turbine blade in response to loading on the turbine blade.

The first and second wall portions may be flexible.

The first and second wall portions may be configured for coupling to a rigid element. The rigid element may define the leading edge of the turbine blade.

The first and second wall portions may be trailing edge first and second wall portions. The first and second wall portions may be configured for coupling to leading edge first and second wall portions. The first trailing edge wall portion and the first leading edge wall portion may collectively form the pressure side of the turbine blade. The second trailing edge wall portion and the second leading edge wall portion may collectively form the suction side of the turbine blade.

The first and second wall portions may be configured for retro-fitting to an existing turbine blade, for example to upgrade or repair an existing turbine blade.

In a fourth aspect there is provided a kit of parts for a turbine blade, the kit of parts comprising the trailing edge arrangement of the third aspect.

The invention is defined by the appended claims. However, for the purpose of the present disclosure, it will be understood that features defined above in accordance with any aspect of the present disclosure or below relating to any specific embodiment of the disclosure may be utilised, either alone or in combination with any other defined feature, in any other aspect or embodiment or to form a further aspect or embodiment of the disclosure.

### BRIEF DESCRIPTION OF DRAWINGS

These and other aspects will now be described by way of example with reference to the accompanying drawings, of which:

FIG. 1 shows a turbine;

FIG. 2a shows a cross-section of a turbine blade of the turbine of FIG. 1;

FIG. 2b shows a perspective view of the sectioned turbine blade of FIG. 2a;

FIG. 3 shows a cross-section of another turbine blade;

FIGS. 4a, 4b and 4c show cross section views of a trailing edge arrangement coupled to a turbine blade;

FIG. 5 shows the deformation of another turbine blade under different loads; FIG. 6 shows a graph of lift coefficient of the turbine blade of FIG. 5 under different loads;

FIG. 7 shows a graph of drag coefficient of the turbine blade of FIG. 5 under different loads;

FIG. 8 shows pressure distribution for the turbine blade of FIG. 5 set at a 10° angle of attack under different loads;

FIG. 9 shows a graph of torque during a gust acting on the turbine blade of

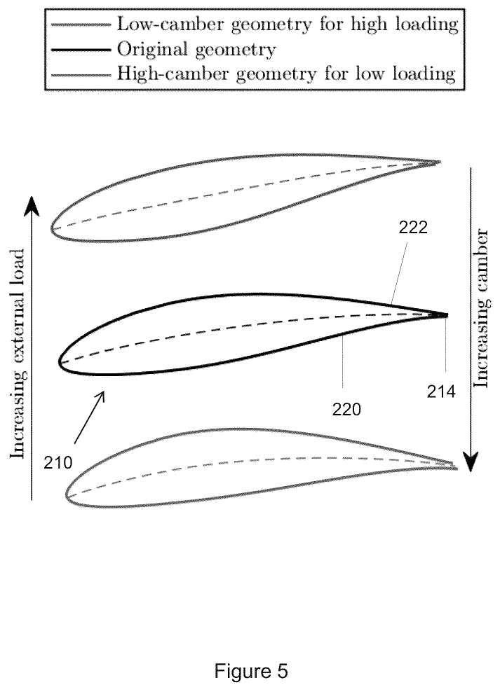

FIG. 5 compared to a rigid blade; and

FIG. 10 shows a graphs of torque during a gust acting on the turbine blade of

FIG. 5 compared to a rigid blade.

### DETAILED DESCRIPTION OF THE DRAWINGS

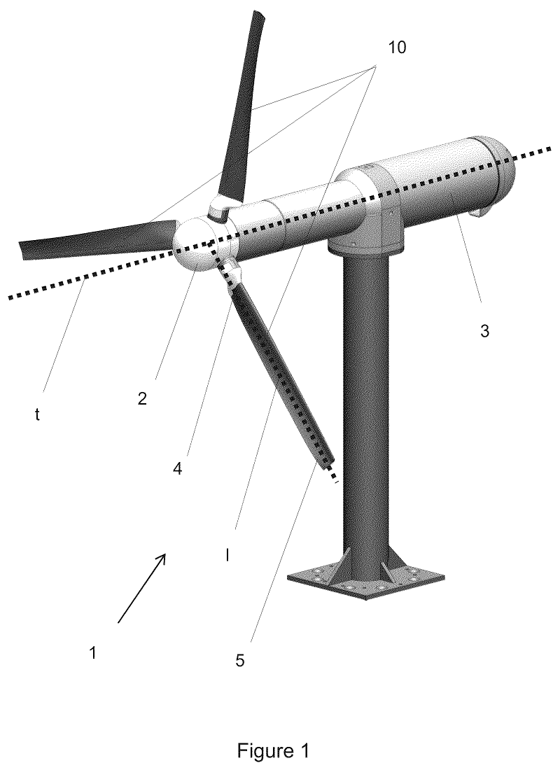

FIG. 1 shows a turbine 1. The turbine 1 comprises a hub 2 and a plurality of turbine blades 10 attached to the hub 2. The turbine 1 comprises three turbine blades 10, however alternative turbines may comprise more or less than three turbine blades, for example 1, 2, 4, 5, 6, . . . , n turbine blades. The hub 2 defines an axis of rotation r. The turbine blades 10 extend radially from the hub 2. The turbine blades 10 are circumferentially spaced around the hub 2, in particular the turbine blades 10 are equally circumferentially spaced. The turbine blades 10, and therefore also the hub 2, are rotatable around the axis r in response to loading on the turbine blades 10 from fluid (e.g. water or air) passing over the turbine blades 10. The hub 2 is connected to a generator 3 via a shaft (not shown). This connection may or may not include a gearbox, e.g., a reduction system. The shaft is fixed with the hub 2 so that rotation of the hub 2 causes rotation of the shaft. The generator 3 is configured to convert the kinetic energy of the shaft rotation into electrical energy.

Each turbine blade 10 comprises a root 4 which is an end of the turbine blade 10 proximal the hub 2. Each turbine blade 10 comprises a tip 5 which is the end of the turbine blade 10 distal the hub 2. Each turbine blade defines a longitudinal axis I extending between the root 4 and the tip 5. The longitudinal axis I extends radially. The length of the turbine blade 10 along the longitudinal axis I between the root 4 and the tip 5 is referred to as the blade span. Each turbine blade 10 has the same structure along the longitudinal axis I, however the cross-sectional shape of each turbine blade 10 varies along the longitudinal axis I.

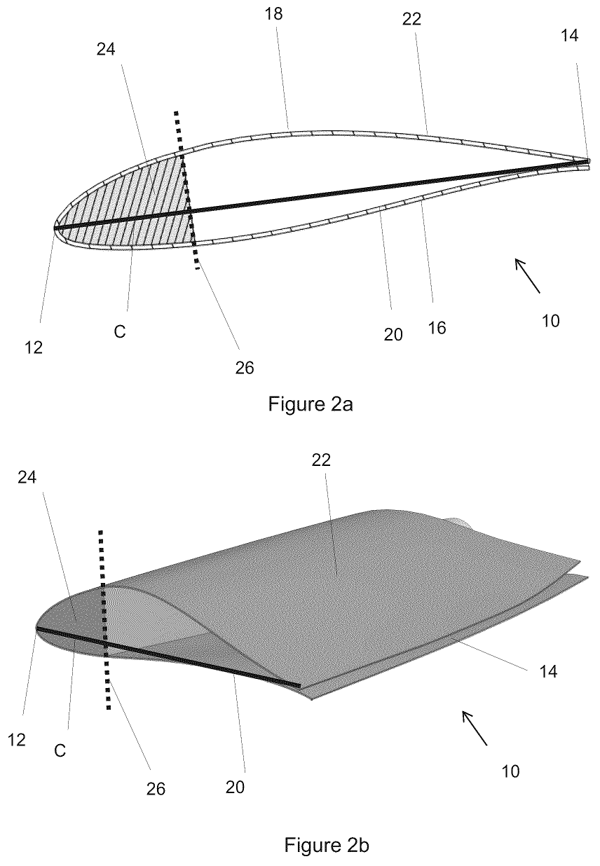

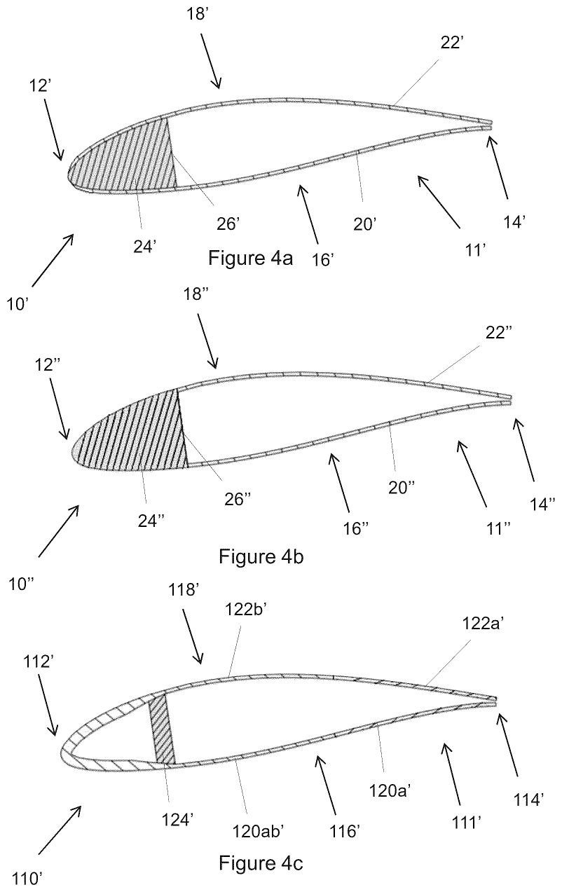

FIGS. 2a and 2b show sectional views of one of the turbine blades 10 of turbine 50 to show the structure of the turbine blade 10. The turbine blade 10 comprises a leading edge 12, a trailing edge 14, a pressure side 16, and a suction side 18. Each of the pressure side 16 and the suction side 18 extend between the leading edge 12 and the trailing edge 14. The pressure side 16 is formed of a first wall 20. The suction side 18 is formed of a second wall 22. The first wall 20 and the second wall 22 are configured to be independently deformable and move relative to each other proximal the trailing edge 14 in response to loading on the turbine blade 10. Beneficially, the deformation of the walls accommodates and limits varying loads on the turbine blade via a passive system, as will be explained in greater detail with reference to FIGS. 4 to 9.

The turbine blade 10 defines a chord C. The first wall 20 and the second wall 22 are configured to translate in a direction perpendicular to a plane defined by the chord C and the longitudinal axis I. Additionally, the first wall 20 and the second wall 22 are configured to translate in a direction along the chord C, e.g. in the chord-wise direction. The turbine blade 10 defines a quarter-chord position 26. The first wall 20 and the second wall 22 are configured to deform by rotating around the quarter-chord position 26. The rotation of the first wall 20 and the second wall 22 is equivalent to the aggregation of the translation in the direction perpendicular to a plane defined by the chord C and the longitudinal axis I and the translation in the chord-wise direction.

Each wall 20, 22 is a sheet of material, e.g. a thin sheet of material, extending between the leading edge 12 and the trailing edge 14. The first wall 20 has an S-shaped form, e.g. an open or loose S shaped form, between the leading edge 12 and the trailing edge 14. The second wall 22 has an arc shaped form between the leading edge 12 and the trailing edge 14. The first and second walls 20, 22 are connected and contiguous at the leading 12 edge such that the first and second walls 20, 22 are integrally formed. The turbine blade 10 has an open geometry such that the first and second walls 20, 22 are independently moveable at the trailing edge 14 and can move in and out of contact with each other at the trailing edge under varying loads. The first and second walls 20, 22 have the same thickness, and a uniform thickness between the leading edge 12 and the trailing edge 14.

The turbine blade 10 further comprises a rigid element in the form of a rigid block 24 that can be used to ensure that the turbine blade 10 is rigid proximal the leading edge 12 while the remainder of the turbine blade 10 is able to flex and deform. The rigid block 24 provides both support for the walls 20, 22 and structural rigidity to the leading edge 12. The rigid block 24 fills a volume within the turbine blade 10 between the leading edge 12 and the quarter-chord position 26, allowing for full flexibility of the walls 20, 22 between that position and the trailing edge 14 while retaining the shape of the leading edge 12. The remaining volume of the turbine blade 10 between the quarter chord position and the trailing edge 14 is hollow.

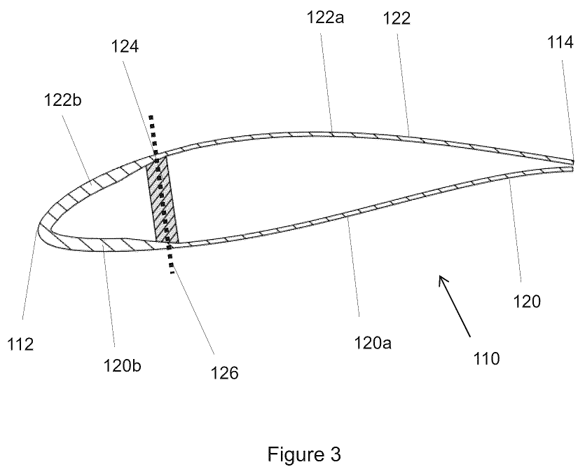

FIG. 3 shows another turbine blade 110. The turbine blade 110 substantially corresponds to the turbine blade 10, except for the features described below. Like features are identified with like reference numbers, prefixed by 1.

FIG. 3 illustrates the thickness of the walls 120, 122 increased around the leading edge 112. Each of the first and second walls 120, 122 comprises a flexible portion 120a, 122a and a rigid portion 120b, 122b. The rigid portions 120b, 122b are more rigid/less flexible than the flexible portions 120a, 122a. The flexible portions 120a, 122a of the first and second walls 120, 122 are independently deformable and move relative to each other proximal the trailing edge 114. The rigid portions 120b, 122b comprise the leading edge 112. The rigid portions 120b, 122b of the first and second walls 120, 122 are connected and contiguous at the leading edge 112 such that they are integrally formed. The flexible portions 120a, 122a are longer than the rigid portions 120b, 122b. A transition between the rigid portions 120b, 122b and the flexible portions 120a, 122a is around the quarter-chord position 126. The flexible portions 120a, 122a have a uniform thickness. The rigid portions 120b, 122b have a larger thickness than the flexible portions 120a, 122a.

The turbine blade 110 of FIG. 2 has a different configuration of a rigid element in the turbine blade 110 that can be used to ensure that the leading edge 112 is rigid while the remainder of the turbine blade 110 is able to flex and deform. The turbine blade 110 is substantially hollow. The turbine blade 110 comprises a rigid bar 124 rather than a rigid block. The rigid bar 124 extends between the first wall 120 and the second wall 122, within the turbine blade 110. The rigid bar 124 provides structural support to the walls 120, 122 proximal the leading edge 112. The rigid bar 124 is a thin solid spar. The rigid bar 124 is positioned within the turbine blade 110 at around the quarter-chord position 126, allowing for full flexibility of the walls 120, 122 past that position while retaining the shape of the leading edge 112. The rigid bar supports the walls 120, 122 at the transitions between the rigid portions 120b, 122b and the flexible portions 120a, 122a.

FIGS. 4a, 4b and 4c show sectional views of a turbine blade 10′, 10″, 110′ comprising alternative trailing edge arrangements 11′, 11″, 111′. The trailing edge arrangements 11′, 11″, 111′ may be retrofitted to an existing turbine blade, e.g. replacing at least the trailing edge of an existing turbine blade.

Referring to FIG. 4a, the trailing edge arrangement 11′ comprises a first wall portion 20′ which forms a pressure side 16′ of the turbine blade 10′. The trailing edge arrangement 11′ further comprises a second wall portion 22′ which forms a suction side 18′ of the turbine blade 10′. The first wall portion 20′ and the second wall portion 22′ are configured to be independently deformable and move relative to each other proximal a trailing edge 14′ of the turbine blade 10′ in response to loading on the turbine blade 10′. The first and second wall portions 20′, 22′ are flexible, at least proximal the trailing edge 14′. The turbine blade 10′ further comprises a rigid element in the form of a rigid block 24′. The rigid block 24′ extends between the leading edge 12′ and a quarter-chord position 26′. The first and second wall portions 20′, 22′ are coupled to the rigid block 24′ proximal the leading edge 12′.

Referring to FIG. 4b, the trailing edge arrangement 11″ comprises a first wall portion 20″ which forms a portion of the pressure side 16″ of the turbine blade 10″. The trailing edge arrangement 11″ further comprises a second wall portion 22″ which forms a portion of the suction side 18″ of the turbine blade 10″. The first wall portion 20″ and the second wall portion 22″ are configured to be independently deformable and move relative to each other proximal a trailing edge 14″ of the turbine blade 10″ in response to loading on the turbine blade 10″. The first and second wall portions 20″, 22″ are flexible. The turbine blade 10″ further comprises a rigid element in the form of a rigid block 24″. The rigid block 24″ extends between the leading edge 12″ and a quarter-chord position 26″. The first and second wall portions 20″, 22″ are coupled to the rigid block 24″ at the quarter-chord position 26″. The first wall portion 20″ and the rigid block 24″ collectively form the pressure side 16″ of the turbine blade 10″. The second wall portion 22″ and the rigid block 24″ collectively form the suction side 18″ of the turbine blade 10″.

Referring to FIG. 4c, the trailing edge arrangement 111′ comprises a first wall portion 120a′ which forms a portion of the pressure side 116′ of the turbine blade 110′. In particular, the first wall portion 120a′ forms a portion of the pressure side 116′ proximal the trailing edge 114′ of the turbine blade 110′. The first wall portion 120a′ may be referred to as a first trailing edge wall portion 120a′. The trailing edge arrangement 111′ further comprises a second wall portion 122a′ which forms a portion of the suction side 118′ of the turbine blade 110′. In particular, the second wall portion 122a′ forms a portion of the pressure side 118′ proximal the trailing edge 114′ of the turbine blade 110′. The second wall portion 122a′ may be referred to as a first trailing edge wall portion 122a′. The first wall portion 120a′ and the second wall portion 122a′ are configured to be independently deformable and move relative to each other proximal the trailing edge in response to loading on the turbine blade 110′. The first and second wall portions 120a′, 122a′ are flexible. The turbine blade 110′ further comprises a first leading edge wall portion 120b′. The first trailing edge wall portion 120a′ is coupled to the first leading edge wall portion 120b′. Collectively the first leading edge wall portion 120b′ and the first trailing edge wall portion 120a′ form the pressure side 116′ of the turbine blade 110′. The turbine blade 110′ further comprises a second leading edge wall portion 122b′. The second trailing edge wall portion 122a′ is coupled to the second leading edge wall portion 122b′. Collectively the second leading edge wall portion 122b′ and the second trailing edge wall portion 122a′ form the suction side 118′ of the turbine blade 110. The first and second leading edge wall portions 120b′. 122b′ are substantially rigid, e.g. more rigid than the first and second trailing edge wall portions 120a′, 122a′. The first and second leading edge wall portions 120b′. 122b′ meet at the leading edge 112′ and are contiguous. The turbine blade 110′ further comprises a rigid element in the form of a rigid bar 124′. The rigid bar 124′ supports the first and second leading edge wall portions 120b′, 122b′.

Another turbine blade 210 is shown in FIG. 5. The turbine blade 210 substantially corresponds to the turbine blade 10 of FIGS. 2a and 2b and the turbine blade 110 of FIG. 3, but does not comprise any features for maintaining the rigidity of the leading edge. Like features are identified with like reference numbers, prefixed by 2. For each of the turbine blades 10, 110, 210 described herein, the deformation of the first and second walls 20, 22, 120, 122, 220, 222 causes a change in the camber of the turbine blade 10, 110, 210. FIG. 5 shows the deformation of the turbine blade 210, at a cross-section located at 75% of the turbine blade span, when the pressure field acting on the turbine is either increased or decreased by 10 % from the design load conditions. The middle cross-section of FIG. 5 shows a neutral camber geometry, e.g. the camber geometry under the design load conditions that does not result in any deformation of the walls 220, 222. The stiffness of the walls 220, 222 is selected so that a camber of the turbine blade reduces under high, e.g. higher-than-design, load. The top cross-section of FIG. 5 shows a low-camber geometry that occurs under high load. The first and second walls 220, 222 straighten at least proximal the trailing edge 214 under high load. Vice-versa, under low, e.g. lower-than-design load, the camber of the turbine blade 210 increases. The bottom cross-section of FIG. 5 shows a high-camber geometry that occurs under low load. The first and second walls 220, 222 bend at least proximal the trailing edge 214 under low load.

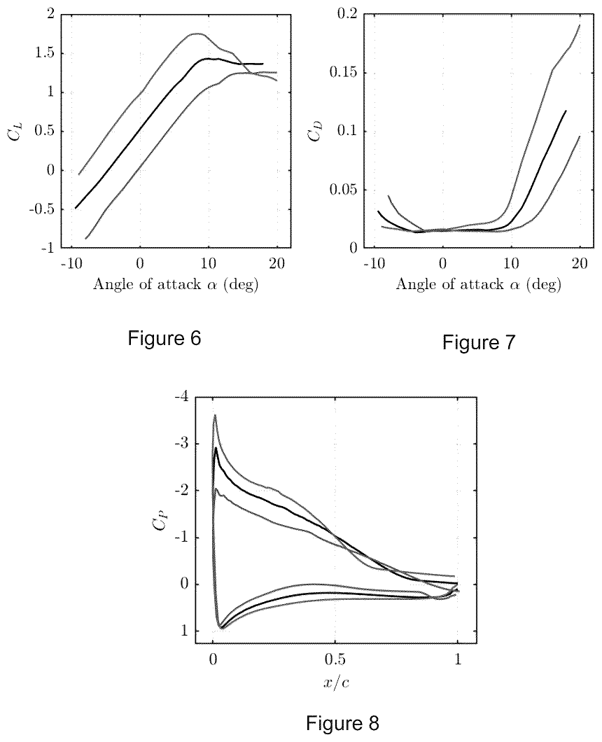

FIGS. 6 and 7 demonstrate the effect of the change in camber on the lift and drag coefficients of the turbine blade 210 at varying angles of attack. The middle line relates to the neutral camber geometry. The bottom line in FIGS. 6 and 7 represents low load, high camber geometry. In the conditions for which a low load is experienced by the turbine blade 210, the turbine blade 210 deforms to have a high-camber geometry and the load increases as the lift and draft coefficients increase. This in turn causes both the power generation and the blade geometry to settle at an equilibrium. The vice-versa is true for conditions that cause high load on the turbine blade 210. The top line in FIGS. 6 and 7 represents high load, low camber geometry. The turbine blade 210 deforms to reduce its camber and consequently the load, until an equilibrium is found.

FIG. 8 plots the pressure distribution on the turbine blade 210 during operation of a turbine, at a 10° angle of attack e.g. the angle between the flow direction and the chord of the turbine blade 210. The outer line represents high load, low camber geometry. The inner line represents low load, high camber geometry. It can be appreciated that the low load, high camber geometry results in a higher pressure coefficient than both the neutral camber geometry and the low camber geometry.

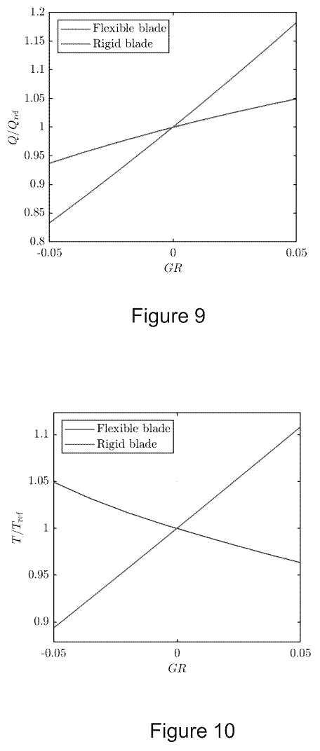

FIGS. 9 and 10 report preliminary data, obtained by means of a low-order code, showing the change in torque Q and thrust T when the incoming current speed is increased by a given ratio (GR) compared to the design condition, e.g. simulating a gust. The results are shown for turbine blade 210, and for a known rigid blade. For positive GR (e.g. an increase in free-current speed) the flexible blade 210 limits the torque transferred to a turbine generator, preventing overloading of the generator and of a related turbine structure. For negative GR (e.g. a decrease in free-current speed), the power generated by a turbine comprising the turbine blade 210 is larger than with a rigid turbine blade. This leads to a more predictable power production from turbine.

It will be understood that various modifications may be made without departing from the scope of the invention as defined in the claims.

1. A turbine blade comprising:
a leading edge;
a trailing edge;
a pressure side; and
a suction side;
wherein each of the pressure side and the suction side extend between the leading edge and the trailing edge;
wherein the pressure side is formed of a first wall;
wherein the suction side is formed of a second wall; and
wherein the first wall and the second wall are configured to be independently deformable and move relative to each other proximal the trailing edge in response to loading on the turbine blade.

2. The turbine blade of claim 1, wherein the first and second walls have a selected stiffness such that a camber of the turbine blade reduces under high load and increases under low load.

3. The turbine blade of claim 1, wherein the first and second walls are independently rotatable and/or translatable at the trailing edge and can move in and out of contact with each other at the trailing edge in response to loading on the turbine blade.

4. The turbine blade of claim 1, wherein the first wall is formed of a first material and wherein the second wall is formed of a second material.

5. The turbine blade of claim 4, wherein the first material and the second material are the same material or are different materials.

6. The turbine blade of claim 5, wherein the first material and/or the second material is a composite material.

7. The turbine blade of claim 5, wherein the first material and/or the second material is an isotropic material.

8. The turbine blade of claim 6, wherein the first material and/or the second material comprises or is formed of an elastomer.

9. The turbine blade of claim 1, wherein the first and second walls comprise a rigid portion proximal the leading edge.

10. The turbine blade of claim 1, wherein the turbine blade comprises a rigid element extending between the first wall and the second wall proximal the leading edge.

11. The turbine blade of claim 10, wherein the rigid element comprises a rigid bar extending between the first and second walls.

12. The turbine blade of claim 11, wherein the rigid bar is at a quarter-chord position.

13. The turbine blade of claim 10, wherein the rigid element is a rigid block filling a volume of the turbine blade proximal the leading edge.

14. The turbine blade of claim 13, wherein the rigid block fills a volume of the turbine blade between the leading edge and a quarter-chord position.

15. A turbine comprising one or more turbine blades according to claim 1.

16. The turbine of claim 15, wherein the turbine is a tidal turbine or a wind turbine.

17. A trailing edge arrangement for a turbine blade, the trailing edge arrangement comprising:
a first wall portion configured to form at least a portion of a pressure side of the turbine blade, and
a second wall portion configured to form at least a portion of a suction side of the turbine blade,
wherein the first wall portion and the second wall portion are configured to be independently deformable so as to move relative to each other proximal the trailing edge of the turbine blade in response to loading on the turbine blade.

18. A kit of parts for a turbine blade, the kit of parts comprising the trailing edge arrangement of claim 17.
